(19) United States
(12) Patent Application Publication
(10) Pub. No.: US 2026/0040250 A1
(43) Pub. Date: Feb. 5, 2026

(54) SATELLITE LOSS OF SIGNAL PREDICTION USING TIMING ADVANCE VALUES

(71) Applicant: T-Mobile USA, Inc., Bellevue, WA (US)

(72) Inventors: Christopher Bailey, Overland Park, KS (US); Ryan P. Dreiling, Shawnee, KS (US)

(21) Appl. No.: 18/789,508

(22) Filed: Jul. 30, 2024

(51) Int. Cl. H04W 56/00; H04B 7/185

(52) U.S. Cl. CPC H04W 56/0045; H04B 7/18513

(57) ABSTRACT

The present technology relates to satellite loss prediction using timing advance values. In aspects, a wireless device receives a first timing advance value from a satellite, followed by a series of second timing advance values over a period of time. The device determines the rate of change of the second timing advance values. Using this rate of change, the wireless device predicts a specific time at which a third timing advance value, equal or similar to the first timing advance value, will be received. The device then outputs an indication that it will lose access to the satellite at the predicted time. In doing so, a user of the wireless device can prepare for loss of the satellite.

### BACKGROUND

Current wireless communications systems utilize base stations to communicate with a user equipment (UE). Base stations can be located at the surface of the Earth and support telecommunications coverage in a surrounding area. When in a coverage region of the base station, the user equipment can connect with the base station to communicate data through the network. In other cases, devices can communicate directly with an orbiting satellite. The user equipment can connect to the satellite when within a coverage region of the satellite. In general, a satellite can provide a larger coverage region and can more easily provide coverage to remote locations. Accordingly, network providers are utilizing non-terrestrial networks to increase coverage and provide improved networks.

### BRIEF DESCRIPTION OF THE DRAWINGS

Detailed descriptions of implementations of the present invention will be described and explained through the use of the accompanying drawings.

FIG. 1 illustrates a wireless communications system that can implement aspects of the present technology.

FIG. 2 illustrates an example of timing advance values received from a satellite in accordance with aspects of the present technology.

FIG. 3 illustrates an example method for satellite loss prediction using timing advance values in accordance with aspects of the present technology.

FIG. 4 illustrates components of a computing device that can implement aspects of the present technology.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Wireless communication technologies utilize satellites to improve network coverage. Given that satellites are not bound to the surface of the Earth, satellites can provide a larger coverage region than base stations and more easily provide coverage in remote locations. Unlike base stations, satellites orbit the Earth, and in doing so, provide network coverage to different areas over time. These satellites travel along different orbits and thus provide different coverage areas (e.g., larger coverage areas when orbiting at a greater distance from the Earth). For some satellite constellations, the orbital geometries of these constellations may not allow the satellites to provide coverage to a particular location on the Earth at all times. Accordingly, a wireless device at a particular location may only stay connected to a satellite for a particular period of time.

Users are often unaware of when they will lose access to a satellite. For example, a wireless device can lose wireless service without providing any warning to the user. Without warning, the user may be unable to prepare for the service outage, thereby leading to frustration due to unexpected loss of service while the device is being used. For example, the wireless device may lose wireless service while the user is in the middle of sending a communication, downloading data, or engaging in another activity that relies on the wireless service.

While some systems may be able to determine the location of satellites, and thus, the coverage region they provide during any period of time, these systems often require large amounts of additional data and complex calculations. For example, satellite almanac information can be used to determine the location of satellites. Almanac information includes the satellite's orbital parameters, such as its position, velocity, and trajectory, which can be used to calculate its coverage region on the Earth's surface. These calculations can be complex and require constant updates to ensure that the almanac information is accurate and up to date. Thus, it may be inefficient or impossible to provide almanac information to a wireless device to enable the wireless device to determine when it has access to a particular satellite.

To address these issues and others, the present technology can utilize timing advance values, which are already communicated between a wireless device and a satellite, to determine when the wireless device will lose access to the satellite. In doing so, the wireless device can determine when it is going to lose access to the satellite without requiring additional information about the satellite, such as almanac information, and without requiring expensive updates or calculations. The wireless device can then notify the user ahead of time of when they will lose access to the satellite, allowing the user to plan for the service outage. For example, the user can quickly transmit a communication to inform those they are communicating with that they are about to lose service or quickly finish up any operations on the device that require wireless service.

Timing advance values play a critical role in ensuring synchronized and efficient data transmission between the wireless device and the base station. The timing advance values can be used to adjust the timing of signal transmission from the wireless device so that the signals from multiple devices arrive at the network in a coordinated manner and in the correct time slot. The timing advance values will vary as the distance between the wireless device and the base station changes. Thus, the timing advance values ensure proper reception of signals from multiple wireless devices, despite those devices being at varying distances from the base station.

In the context of satellites, the timing advance value can be used to determine a distance of the satellite from the wireless device. For example, when a satellite peeks over the horizon and becomes visible to the wireless device, the timing advance value will be at its largest. As the satellite moves overhead, the timing advance value will reach its minimum. Then, as the satellite moves back over the horizon, the timing advance value will increase. In general, the wireless device will lose access to the satellite at approximately the same timing advance value at which it acquired the satellite. Thus, by predicting when the timing advance value will reach the initial timing advance value at acquisition, the time at which the wireless device will lose access to the satellite can be predicted.

The wireless device can predict when the timing advance will reach the first timing advance value by extrapolating from a rate of change of timing advance values. For example, once timing advance values begin increasing (e.g., when the satellite has begun heading toward the horizon after passing overhead), the rate of change of the timing advance value can be used to approximate at what time the timing advance value will equal the first timing advance value. Thus, the wireless device can predict when it will lose access to the satellite before access is lost and can provide a warning to the user to allow the user to prepare for the service outage.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

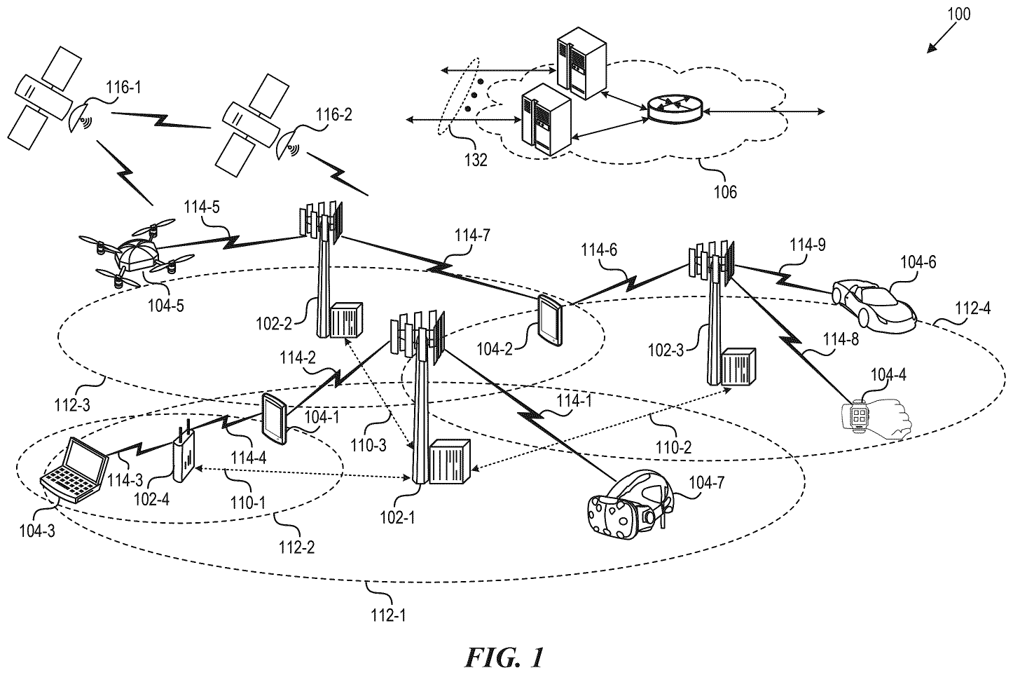

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a UE, a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a non-terrestrial network (NTN) is enabled by one or more satellites, such as satellites 116-1 and 116-2, to deliver services anywhere and anytime and provide coverage in areas that are unreachable by any conventional terrestrial network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and core architecture to achieve Control and User Plane Separation (CUPS) and achieve extremely low user plane latency. In yet another example of 6G, the network 100 can implement a converged Wi-Fi and core architecture to increase and improve indoor coverage.

### Satellite Loss of Signal Prediction Using Timing Advance Values

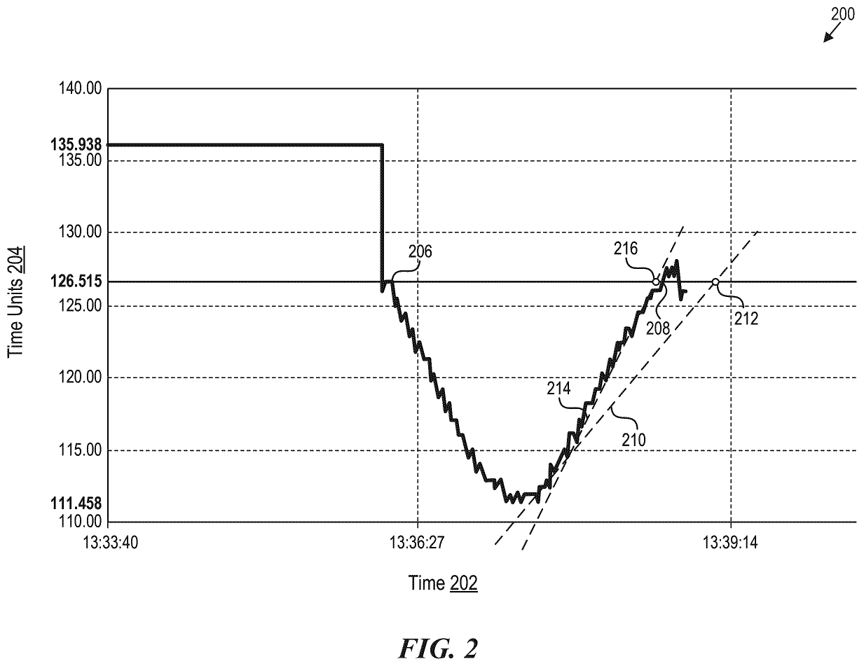

FIG. 2 illustrates an example of timing advance values 200 received from a satellite in accordance with aspects of the present technology. The timing advance values 200 are received over time 202 while the satellite is visible to a wireless device. The timing advance values 200 can be communicated as part of a communication protocol between the wireless device and the satellite. Thus, reception of the timing advance values 200 may require no additional communication between the wireless device and the satellite.

The timing advance values 200 can be used to compensate for a propagation delay between the wireless device and the eNB. For example, in LTE, uplink and downlink transmissions are synchronized, meaning that the wireless device must transmit its uplink signals in a precise time window at the eNB to avoid interference with other wireless devices. Due to the varying distances between the wireless device and the eNB, however, the propagation delay for the uplink signals can vary. The timing advance values 200 are thus used to adjust the uplink transmission timing of the wireless device to ensure that its uplink signals arrive at the eNB within the designated time window, regardless of the distance of the wireless device from the eNB.

The eNB can determine the timing advance values 200. For example, the eNB can measure the timing offset of the uplink signals received from the wireless device. The eNB can then calculate the timing advance values 200 based on the measured timing offset and the estimated propagation delay between the wireless device and the eNB. The eNB can send the timing advance values 200 to the wireless device (e.g., through a dedicated control message). In response to receiving the timing advance values 200, the wireless device can adjust its uplink transmission timing by advancing or delaying its uplink transmissions based on the received timing advance values 200. In aspects, the timing advance values 200 are typically expressed in terms of time units 204.

The wireless device can begin receiving the timing advance values 200 when the satellite is acquired. For example, a first timing advance value 206 can be received when the wireless device acquires the satellite. In aspects, the first timing advance value 206 can be received when the satellite rises above the horizon. Given that the satellite is farther from the wireless device near the horizon, the first timing advance value 206 may be a large timing advance value. The wireless device can store the value of the first timing advance value 206 to predict when the timing advance values 200 will later receive an equivalent value (e.g., equivalent timing advance value 208). As illustrated, the first timing advance value 206 is equal to 126.515 microseconds.

The timing advance values 200 will then decrease over time 202 as the satellite moves from the horizon and passes above the wireless device. The minimum of the timing advance values 200 will be when the satellite is directly overhead or at its maximum elevation angle relative to the wireless device. Then, as the satellite travels from above the wireless device out over the horizon, the timing advance values 200 will increase. In general, the timing advance values 200 will have an arc or near-parabolic shape. The depth or shallowness of the shape will depend on how directly the satellite travels overhead in relation to the wireless device. For example, if the satellite travels directly over the wireless device, the shape of the timing advance values 200 may have a greater depth. If the satellite travels over the wireless device while still partially distanced over the horizon, the shape of the timing advance values 200 may be shallower.

Once the timing advance values 200 begin increasing, the rate of change of one or more of the timing advance values 200 can be used to predict a time at which the wireless device will receive a timing advance value equal to the first timing advance value 206. For example, a first rate of change 210 can be determined from one or more of the timing advance values 200. The first rate of change 210 can then be used to predict a time when the timing advance values 200 will equal the first timing advance value 206. For example, the difference between the first timing advance value 206 and a received timing advance value received at a particular time (e.g., of the time 202) can be divided by the first rate of change 210 to predict the amount of time from the particular time until the timing advance values 200 equal the first timing advance value 206. As an example, the first rate of change 210 is used to determine a prediction 212. An indication that the wireless device will lose access to the satellite at the time that corresponds to the prediction 212 can then be output to the user (e.g., using a display of the wireless device, using a speaker of the wireless device, using a haptic sensor of the wireless device, or using an additional device).

The prediction 212 can be improved by determining an additional rate of change using other ones (e.g., later-received ones) of the timing advance values 200. For example, the other ones of the timing advance values 200 can be used to determine the rate of change 214. The rate of change 214 can then be used to determine a prediction 216 of a time when the one of the timing advance values 200 equals the first timing advance value 206. This prediction 216 can be made using the rate of change 214 in a similar way to how the prediction 212 is made using the first rate of change 210. In aspects, the prediction made using later ones of the timing advance values 200 can result in a more accurate prediction. For example, the prediction 216 can be closer in time to the equivalent timing advance value 208 than the prediction 212. Thus, the user can be provided a more accurate indication of when the wireless device will lose access to the satellite by using the prediction 216.

Although not illustrated, the predictions can be further improved through any mathematical approximations. For example, the wireless device can determine the rate of change of the rate of change of one or more of the timing advance values 200 to further improve the prediction. Alternatively or additionally, the wireless device can use multiple rates of change (e.g., the first rate of change 210 and the rate of change 214) to make a single prediction. In other cases, the wireless device can make multiple predictions and combine them (e.g., average them) to determine a more accurate prediction.

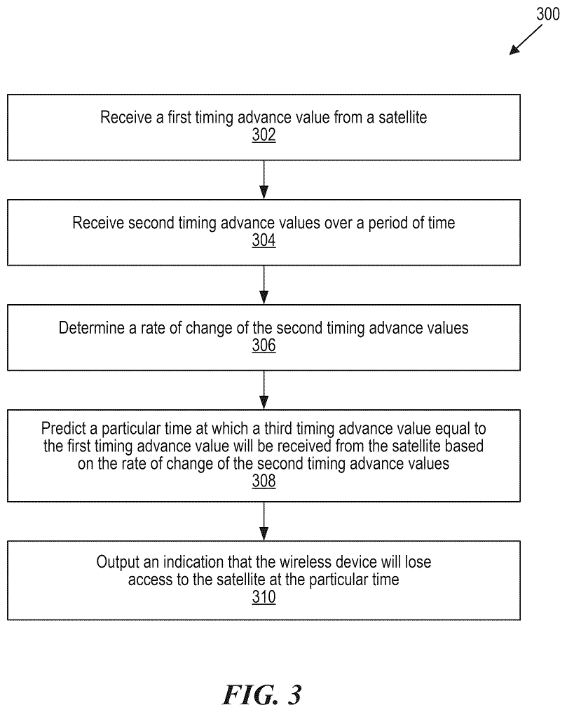

FIG. 3 illustrates an example method 300 for satellite loss prediction using timing advance values in accordance with aspects of the present technology. Although illustrated in a particular configuration, one or more operations of the method 300 may be omitted, repeated, or reorganized. Additionally, the method 300 may include other operations not illustrated in FIG. 3—for example, operations detailed in one or more other methods described herein.

In aspects, the method 300 leverages data exchanged during ordinary communication between a wireless device and an eNB (e.g., timing advance values) to predict when the wireless device will lose acquisition of the satellite. In this way, the method 300 can be used to predict when the wireless device will lose acquisition of the satellite without requiring additional information about the satellite, such as almanac information.

Moreover, one or more operations of the method 300 may only be performed once the wireless device determines that it is connected to a satellite network. The wireless device can determine that it is connected to a satellite network based on network information broadcasted by the network. For example, networks can broadcast an associated Public Land Mobile Network (PLMN) code. The wireless device can receive the PLMN code and determine the type of network with which it is associated. For example, the wireless device can determine that it is connected with a satellite network. Once determined that the device is connected with a satellite network, the wireless device can perform operations to predict when the wireless device will lose access to a satellite of the satellite network (e.g., by determining a rate of change from one or more of the timing advance values and extrapolating a prediction of when the wireless device will lose access to the satellite based on the rate of change).

At 302, the wireless device receives a first timing advance value from the satellite. In aspects, the first timing advance value can correspond to an initial timing advance value received when the wireless device acquires the satellite. In other cases, the first timing advance value can be one of the first few timing advance values received after the wireless device acquires the satellite. Accordingly, the first timing advance value may be a large value (with respect to later-received values) received when the satellite peeks over the horizon. The first timing advance value can be received in the course of communications between the wireless device and the satellite. For example, the wireless device can receive the first timing advance value through a dedicated control message.

At 304, the wireless device receives second timing advance values over a period of time. The second timing advance values can be a portion of timing advance values received after the reception of the first timing advance value. In aspects, the timing advance values exchanged between the wireless device and the satellite (e.g., the first timing advance value and the second timing advance values) can have an arc or near-parabolic shape, as illustrated in FIG. 2. Thus, the timing advance values can decrease until hitting a minimum value (e.g., when the satellite is at its maximum elevation angle relative to the wireless device) and then begin to increase from the minimum value. The second timing advance values can be received after the timing advance values hit their minimum. The timing advance values can be received at constant time intervals or over varying time intervals. Like the first timing advance value, the wireless device can receive other timing advance values through communications with the satellite, for example, through dedicated control messages.

At 306, a rate of change of the second timing advance values is determined. For example, the rate of change can be determined by dividing the difference in the second timing advance values by the difference in the times at which the second timing advance values were received. Once determined, the rate of change can be used to predict at what time the timing advance values will equal the first timing advance value. The second timing advance values can be increasing timing advance values collected after the timing advance values have reached their minimum. In this way, the rate of change will be positive, ensuring that a prediction can be made about when the timing advance values will have a value equal to the first timing advance value.

At 308, the rate of change of the second timing advance values is used to predict a particular time at which a third timing advance value equal to the first timing advance value will be received from the satellite. For example, the difference between the third timing advance value and a timing advance value of the second timing advance values can be divided by the rate of change of the second timing advance values to predict the amount of time from the time at which that second timing advance value was received until the third timing advance value will be received.

Although described as being equal to the first timing advance value, the third timing advance value could instead be similar but not equal to the first timing advance value. For example, the third timing advance value can be within 0.1 percent, 1 percent, 2 percent, 5 percent, 10 percent, or any percentage therebetween of the first timing advance value. Thus, the prediction can be used to determine when a timing advance value similar to, but perhaps not exactly equal to, the first timing advance value will be received from the satellite.

The prediction can further be improved by determining an additional rate of change using other (e.g., later-received) timing advance values. For example, a new rate of change can be determined from these other timing advance values and can be used to determine a new prediction of the time when the third timing advance value will be received. This prediction can be made in a similar manner as the previous prediction but using the new rate of change and these other timing advance values. In aspects, the prediction made using later ones of the timing advance values can result in a more accurate prediction.

Alternatively or additionally, the predictions can be further improved through any mathematical approximations. For example, the wireless device can determine the rate of change of the rate of change of the second timing advance values to further improve the prediction. Alternatively or additionally, the wireless device can use multiple rates of change (e.g., calculated using different ones of the second timing advance values) to make a single prediction. In other cases, the wireless device can make multiple predictions and combine them (e.g., average them) to determine a more accurate prediction.

At 310, an indication that the wireless device will lose access to the satellite at the particular time determined at 308 is output. For example, the wireless device can output a visual indication on a display of the wireless device to inform the user that the wireless device will lose access to the satellite at the particular time. Alternatively or additionally, the wireless device can output an audible notification that the wireless device will lose access to the satellite at the particular time. In yet other aspects, the wireless device can output the indication using haptic sensors.

Moreover, when multiple predictions of the particular time are made, the wireless device can output multiple indications or continue to update the indication as new or more accurate predictions are made. For example, when a new prediction is made, the wireless device can output an indication of the new prediction on the display of the device. Alternatively or additionally, the wireless device can maintain a constant display of the initial prediction (e.g., as a countdown on the display of the wireless device) that updates as new predictions are made. In yet other aspects, the indications of the updated predictions can be conveyed to the user through any other form (e.g., through audio, haptics, or other visual indications).

### Computing System

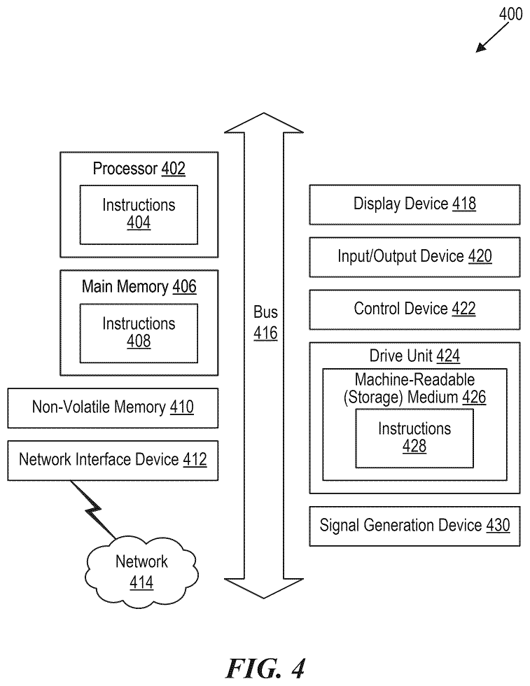

FIG. 4 is a block diagram that illustrates an example of a computing system 400 in which at least some operations described herein can be implemented. As shown, the computing system 400 can include: one or more processors 402, main memory 406, non-volatile memory 410, a network interface device 412, a video display device 418, an input/output device 420, a control device 422 (e.g., keyboard and pointing device), a drive unit 424 that includes a machine-readable (storage) medium 426, and a signal generation device 430 that are communicatively connected to a bus 416. The bus 416 represents one or more physical buses and/or point-to-point connections that are connected by appropriate bridges, adapters, or controllers. Various common components (e.g., cache memory) are omitted from FIG. 4 for brevity. Instead, the computing system 400 is intended to illustrate a hardware device on which components illustrated or described relative to the examples of the figures and any other components described in this specification can be implemented.

The computing system 400 can take any suitable physical form. For example, the computing system 400 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 400. In some implementations, the computing system 400 can be an embedded computing system, a system-on-chip (SOC), a single-board computing system (SBC), or a distributed system such as a mesh of computing systems, or it can include one or more cloud components in one or more networks. Where appropriate, one or more computing systems 400 can perform operations in real time, in near real time, or in batch mode.

The network interface device 412 enables the computing system 400 to mediate data in a network 414 with an entity that is external to the computing system 400 through any communication protocol supported by the computing system 400 and the external entity. Examples of the network interface device 412 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 406, non-volatile memory 410, machine-readable medium 426) can be local, remote, or distributed. Although shown as a single medium, the machine-readable medium 426 can include multiple media (e.g., a centralized/distributed database and/or associated caches and servers) that store one or more sets of instructions 428. The machine-readable medium 426 can include any medium that is capable of storing, encoding, or carrying a set of instructions for execution by the computing system 400. The machine-readable medium 426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 404, 408, 428) set at various times in various memory and storage devices in computing device(s). When read and executed by the processor 402, the instruction(s) cause the computing system 400 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A wireless device comprising:
at least one processor; and
at least one non-transitory, computer-readable storage medium storing instructions that, when executed by the at least one processor, cause the wireless device to:
receive, from a satellite of a satellite communication network, a first timing advance value associated with the wireless device and the satellite;
following the reception of the first timing advance value, receive, from the satellite and over a period of time, second timing advance values associated with the wireless device and the satellite;
determine a rate of change of the second timing advance values;
predict, based on the rate of change of the second timing advance values, a particular time at which a third timing advance value equal to the first timing advance value will be received from the satellite, the third timing advance value associated with the wireless device and the satellite; and
output an indication that the wireless device will lose access to the satellite at the particular time.

2. The wireless device of claim 1, wherein the second timing advance values are received such that the second timing advance values are increasing over time.

3. The wireless device of claim 1, wherein:
the wireless device further comprises a display; and
the instructions further cause the wireless device to output, on the display, the indication that the wireless device will lose access to the satellite at the particular time.

4. The wireless device of claim 1, wherein the first timing advance value is received in response to the wireless device acquiring the satellite.

5. The wireless device of claim 1, wherein:
the instructions further cause the wireless device to determine that the wireless device is connected to the satellite communication network; and
predicting the particular time at which the third timing advance value will be received from the satellite is in response to determining that the wireless device is connected to the satellite communication network.

6. The wireless device of claim 5, wherein the instructions further cause the wireless device to determine that the wireless device is connected to the satellite communication network based on a Public Land Mobile Network (PLMN) code of the satellite communication network.

7. The wireless device of claim 1, wherein the instructions further cause the wireless device to:
determine a rate of change of fourth timing advance values received from the satellite after the second timing advance values;
determine, based on the rate of change of the fourth timing advance values, an updated prediction of the particular time at which the third timing advance value equal to the first timing advance value will be received from the satellite; and
output the indication that the wireless device will lose access to the satellite at the particular time based on the updated prediction of the particular time.

8. The wireless device of claim 1, wherein the instructions further cause the wireless device to:
determine a rate of change of the rate of change of the second timing advance values; and
predict the particular time at which the third timing advance value will be received from the satellite based on the rate of change of the second timing advance values and the rate of change of the rate of change of the second timing advance values.

9. At least one non-transitory, computer-readable storage medium storing instructions that, when executed by at least one processor, cause the at least one processor to:
receive, from a satellite of a satellite communication network and at a wireless device, a first timing advance value associated with the wireless device and the satellite;
following the reception of the first timing advance value, receive, from the satellite, at the wireless device, and over a period of time, second timing advance values associated with the wireless device and the satellite;
determine a rate of change of the second timing advance values;
predict, based on the rate of change of the second timing advance values, a particular time at which a third timing advance value equal or similar to the first timing advance value will be received from the satellite, the third timing advance value associated with the wireless device and the satellite; and
output an indication that the wireless device will lose access to the satellite at the particular time.

10. The at least one non-transitory, computer-readable storage medium of claim 9, wherein the second timing advance values are received such that the second timing advance values are increasing over time.

11. The at least one non-transitory, computer-readable storage medium of claim 9, wherein the instructions further cause the at least one processor to output, on a display of the wireless device, the indication that the wireless device will lose access to the satellite at the particular time.

12. The at least one non-transitory, computer-readable storage medium of claim 9, wherein the first timing advance value is received in response to the wireless device acquiring the satellite.

13. The at least one non-transitory, computer-readable storage medium of claim 9, wherein:
the instructions further cause the at least one processor to determine that the wireless device is connected to the satellite communication network; and
predicting the particular time at which the third timing advance value will be received from the satellite is in response to determining that the wireless device is connected to the satellite communication network.

14. The at least one non-transitory, computer-readable storage medium of claim 13, wherein the instructions further cause the at least one processor to determine that the wireless device is connected to the satellite communication network based on a Public Land Mobile Network (PLMN) code of the satellite communication network.

15. The at least one non-transitory, computer-readable storage medium of claim 9, wherein the instructions further cause the at least one processor to:
determine a rate of change of fourth timing advance values received from the satellite after the second timing advance values;
determine, based on the rate of change of the fourth timing advance values, an updated prediction of the particular time at which the third timing advance value equal or similar to the first timing advance value will be received from the satellite; and
output the indication that the wireless device will lose access to the satellite at the particular time based on the updated prediction of the particular time.

16. The at least one non-transitory, computer-readable storage medium of claim 9, wherein the instructions further cause the at least one processor to:
determine a rate of change of the rate of change of the second timing advance values; and
predict the particular time at which the third timing advance value will be received from the satellite based on the rate of change of the second timing advance values and the rate of change of the rate of change of the second timing advance values.

17. A method comprising:
receiving, from a satellite of a satellite communication network and at a wireless device, a first timing advance value associated with the wireless device and the satellite,
following the reception of the first timing advance value, receiving, from the satellite, at the wireless device, and over a period of time, second timing advance values associated with the wireless device and the satellite;
determining a rate of change of the second timing advance values;
predicting, based on the rate of change of the second timing advance values, a particular time at which a third timing advance value equal or similar to the first timing advance value will be received from the satellite, the third timing advance value associated with the wireless device and the satellite; and
outputting an indication that the wireless device will lose access to the satellite at the particular time.

18. The method of claim 17, wherein the second timing advance values are received such that the second timing advance values are increasing over time.

19. The method of claim 17, further comprising outputting, on a display of the wireless device, the indication that the wireless device will lose access to the satellite at the particular time.

20. The method of claim 17, wherein the first timing advance value is received in response to the wireless device acquiring the satellite.
